(19) United States
(12) Patent Application Publication
(10) Pub. No.: US 2005/0262039 A1
(43) Pub. Date: Nov. 24, 2005

(54) Method and system for analyzing unstructured text in data warehouse

(75) Inventors: Jeffrey Thomas Kreulen, San Jose, CA (US); James J. Rhodes, San Jose, CA (US); William Scott Spangler, San Martin, CA (US)

Correspondence Address: John L. Rogitz;Rogitz & Associates, Suite 3120, 750 B Street, San Diego, CA, 92101, US

(73) Assignee: International Business Machines Corporation, Armonk, NY (US)

(21) Appl. No.: 10/851,754

(22) Filed: May 20, 2004

(51) Int. Cl. G06F 7/00

(52) U.S. Cl. 707/1

(57) ABSTRACT

A user initially analyzes a statistically significant sample of documents randomly drawn from a data warehouse to create a cached feature space and text classifier, which can then be used to establish a classification dimension in the data warehouse for in depth and detailed text analysis of the entire data set.

### BACKGROUND OF THE INVENTION

1. Field of the Invention

The present invention relates to analyzing unstructured text in data warehouses.

2. Description of the Related Art

A data warehouse can contain data from documents that includes a vast quantity of structured data. It is not unusual for documents in the warehouse to contain unstructured text as well, that is associated with the structured data. For example, a large corporation might have a data warehouse containing customer product report information: Customer Name, Date, Problem Code, Problem Description, etc. Along with these structured fields, there might be an unstructured text field. In this example, the unstructured text could be the customers' comments. As understood herein, a dimension could be implemented in a warehouse that stores the text documents, so that the unstructured text could be related to the structured data. Essentially, a star schema could be created with one of the dimensions containing all of the unstructured text documents.

As also understood herein, any standard on-line analytical tool (OLAP) interface would allow easy navigation through such a warehouse, but a problem arises when the purpose of navigation is to analyze a large set of related text documents. Data warehouses, by definition, are very large and can contain millions of records. To analyze the text of all of these records at one time, e.g., to identify particular recurring customer complaints in the text fields, would be extremely time consuming and would most likely fail do to computer resource consumption. In addition a user might only be interested in a specific subset of documents.

As recognized herein, sampling can be used to identify characteristics in a subset of documents in a data warehouse. However, sampling alone cannot satisfy a searcher who wishes to search the entire corpus. Raw text analysis tools have also been provided but when used alone, on a very large corpus of documents, are time consuming and excessively consume computer resources. That is, existing systems for facilitating data mining in documents containing unstructured text fields either classify all documents from scratch, which is resource intensive, or classify only a sample of the documents, which renders only a partial view of the data. With these critical observations in mind, the invention herein has been provided.

### SUMMARY OF THE INVENTION

One aspect of the invention is a general purpose computer programmed according to the inventive steps herein. The invention can also be embodied as an article of manufacture—a machine component—that is used by a digital processing apparatus and which tangibly embodies a program of instructions that are executable by the digital processing apparatus to undertake the present invention. This invention is realized in a critical machine component that causes a digital processing apparatus to perform the inventive method steps herein. Another aspect of the invention is a computer-implemented method for undertaking the acts disclosed below. Also, the invention may be embodied as a service.

Accordingly, a computer-implemented method is disclosed for analyzing information in a data warehouse which includes selecting a sample of documents from the data warehouse and generating a feature space of terms of interest in unstructured text fields of the documents using the sample. The method also includes generating a default classification using the feature space, and allowing a user to modify the default classification to render a modified classification. At least one classifier is established using the modified classification, and a classification dimension is implemented in the data warehouse using the classifier.

In non-limiting embodiments the method may include adding documents not in the sample to the classification dimension, whereby the classification dimension is useful for searching for documents by classification derived from words in unstructured text fields. The classifier may include a machine-implementable set of rules that can be applied to any data element in the warehouse to generate a label. If desired, the sample may be pseudo-randomly selected. The non-limiting method may include displaying output using an on-line analytical tool (OLAP) tool. The act of generating a default classifier may be undertaken using an e-classifier tool.

In further non-limiting embodiments the method can include identifying a subset of documents in the warehouse, and selecting features from the feature space that are relevant to the subset. The subset may be compared with the sample using the features from the feature space that are relevant to the subset.

In another aspect, a service for analyzing information in a data warehouse of a customer includes receiving a sample of documents in the warehouse, and based on the sample, generating at least one initial classification. The service also includes using the initial classification to generate a classifier, and then using the classifier to add documents not in the sample to a classification dimension. The classification dimension and/or an analysis rendered by using the classification dimension are returned to the customer.

In yet another aspect, a computer executes logic for analyzing unstructured text in documents in a data warehouse. The logic includes establishing, based on only a sample of documents in the warehouse, a classification dimension listing all documents in the warehouse, with the classification dimension being based on words in unstructured text fields in the documents.

In still another aspect, a computer program product has means which are executable by a digital processing apparatus to analyze data in a data warehouse. The product includes means for selecting a sample of documents from the data warehouse, and means for generating at least one feature space of terms of interest in unstructured text fields of the documents using the sample. The product further includes means for generating at least one default classification using the feature space, and means for modifying the default classification to render a modified classification. Means are provided for establishing at least one classifier using the modified classification. Means are also provided for identifying a subset of documents in the warehouse. The product further includes means for selecting features from the feature space that are relevant to the subset, and means for comparing the subset with the sample using the features from the feature space that are relevant to the subset.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system architecture;

FIG. 2 is a schematic diagram showing various tables in the data warehouse;

FIG. 3 is a flow chart of the overall logic;

FIG. 4 is a flow chart of the logic for classifying documents not in the original sample set; and

FIG. 5 is a flow chart of the logic for in-depth analysis of classified documents.

### DETAILED DESCRIPTION OF THE PREFERRED EMBODIMENTS

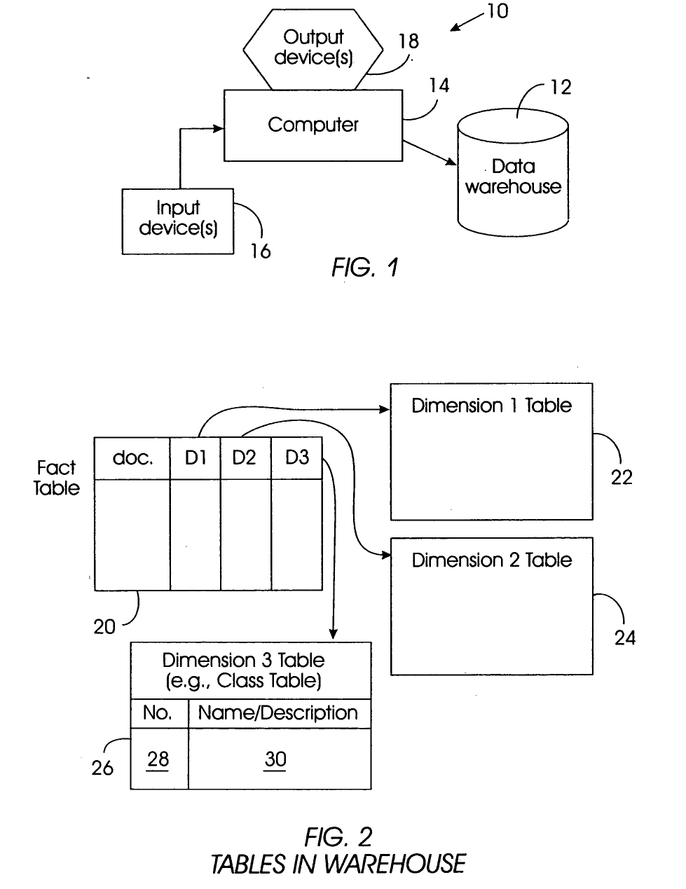

Referring initially to FIG. 1, a system is shown, generally designated 10, for analyzing documents having unstructured text. The system 10 can include one or more data warehouses 12 that may be implemented by a relational database system, file system, or other storage system. A computer 14 for executing the queries accesses the data warehouse 12 over a communication path 15. The path 15 can be the Internet, and it can be wired and/or wireless.

The computer 14 can include an input device 16, such as a keyboard or mouse, for inputting data to the computer 14, as well as an output device 18, such as a monitor. The computer 14 can be a personal computer made by International Business Machines Corporation (IBM) of Armonk, N.Y. that can have, by way of non-limiting example, a 933 MHz Pentium ®III processor with 512 MB of memory. Other digital processors, however, may be used, such as a laptop computer, mainframe computer, palmtop computer, personal assistant, or any other suitable processing apparatus such as but not limited to a Sun® Hotspot™ server. Likewise, other input devices, including keypads, trackballs, and voice recognition devices can be used, as can other output devices, such as printers, other computers or data storage devices, and computer networks.

In any case, the processor of the computer 14 executes certain of the logic of the present invention that may be implemented as computer-executable instructions which are stored in a data storage device with a computer readable medium, such as a computer diskette having a computer usable medium with code elements stored thereon. Or, the instructions may be stored on random access memory (RAM) of the computer 14, on a DASD array, or on magnetic tape, conventional hard disk drive, electronic read-only memory, optical storage device, or other appropriate data storage device. In an illustrative embodiment of the invention, the computer-executable instructions may be lines of C++ code or JAVA.

Indeed, the flow charts herein illustrate the structure of the logic of the present invention as embodied in computer program software. Those skilled in the art will appreciate that the flow charts illustrate the structures of computer program code elements including logic circuits on an integrated circuit, that function according to this invention. Manifestly, the invention is practiced in its essential embodiment by a machine component that renders the program code elements in a form that instructs a digital processing apparatus (that is, a computer) to perform a sequence of function steps corresponding to those shown.

Now referring to FIG. 2, portions of the data structures that may be contained in the data warehouse 12 are illustrated to illuminate the discussion below. A fact table 20 can be provided that is essentially a list of all documents in the data warehouse 12, with each row representing a document and with corresponding numerical values in each row indicating primary keys in other tables (representing respective data dimensions) that contain characteristics of the documents. For example, in each row of the fact table 20, the first column can indicate a document ID, the second column can indicate the primary key in a dimension “1” table 22 (such as, e.g., a time period table) that indicates a dimension value (such as a time period value) associated with the document ID in the first column, while the third column can indicate the document's primary key in a dimension “2” table 24 (such as, e.g., a text table). It is to be appreciated that the data warehouse 12 can contain many tables, each representing a data dimension, and that the fact table 20 contains pointers to each one for each document having an entry in the particular dimension.

Of relevance to the discussion below is that the fact table may also contain pointers to a classification dimension table 26, which is constructed in accordance with principles set forth herein. The classification dimension table 26 may include a primary key column 28 and a classification description column 30 setting forth document classifications derived in accordance with the logic shown in the following flow charts.

Referring now to FIG. 3, the overall document classification logic can be seen. Commencing at block 32, a sample size “n” is established. The sample size “n” can be determined, e.g., using any known formula that calculates a significant sample size for a given confidence level and confidence interval. Moving to block 34, “n” documents are randomly (more precisely, are pseudo-randomly) selected from the data warehouse 12. The random selection may be implemented in any appropriate way, such as, e.g., by creating an integer array containing the entire set of document ID's in the warehouse 12, and then by creating a sample array “S”, which is the size of the sample. Using a (pseudo) random number generator, values may then be randomly selected from the array containing all of the ID's, and if the sample array “S” does not already contain the selected ID, the ID is added to the sample array “S” until the sample array “S” has been completely filled.

Proceeding to block 36, a dictionary of frequently occurring terms in the documents in the sample array “S” is created. In one implementation, each word in the text data set of each document may be identified and the number of documents in which each word occurs is counted. The most frequently occurring words in the corpus compose a dictionary. The frequency of occurrence of dictionary words in each of the documents in the sample array “S” establishes a feature space “F”. The feature space “F” may be implemented as a matrix of non-negative integers wherein each column corresponds to a word in the dictionary and each row corresponds to an example in the text corpus of the documents in the sample array “S”. The values in the matrix represent the number of times each dictionary word occurs in each document in the sample array “S”. Since most of these values will, under normal circumstances, be zero, the feature space “F” matrix is “sparse”. This property of sparseness greatly decreases the amount of storage required to hold the matrix in memory, while incurring only a small cost in retrieval speed.

Proceeding to block 38, using the information in the feature space “F” the documents in the sample array “S” are clustered together on the basis of commonly appearing words in the unstructured text fields to render a text clustering “TC”. Clustering can be accomplished, e.g., by using an e-classifier tool, such as the clustering algorithms marketed as “KMeans”. At block 40 the sampled feature space “F” and text clustering “TC” are saved to an appropriate storage device, usually to the data warehouse 12. Essentially, the taxonomy of the text clustering “TC” establishes a default classification.

Moving to block 42, the user can modify the taxonomy of the text clustering “TC” if desired by viewing the text clustering and moving documents from one cluster to another. Human expert modifications to the taxonomy improve the coherence and usefulness of the classification. Measures of cluster goodness, such as intra-cluster cohesion and inter-cluster dissimilarity, can be used to help the expert determine which classes are the best candidates for automated solutions. Further, clusters can be named automatically to convey some idea of their contents. Examples within each cluster may be viewed in sorted order by typicality. Ultimately, the expert may use all of this information in combination to interactively modify the text categories to produce a classification that will be useful in a business context. U.S. Pat. No. 6,424,971, incorporated herein by reference, discusses some techniques that may be used in this step.

The logic next moves to block 44 to train and test one or more classifiers using the documents in the sample array “S”. To do this, some percentage (e.g. 80%) of the documents may be randomly selected as a training set “TS”. The rest of the documents establish a test set “E”. If a set of “N” different modeling techniques (referred to herein as “classifiers”) are available for learning how to categorize new documents, during the training phase each of the “N” classifiers is given the documents in the training set “TS” that are described using the feature space “F” (i.e., by dictionary word occurrences). Each document in the training set “TS” may also be labeled with a single category. Each classifier uses the training set to create a mathematical model that predicts the correct category of each document based on the documents feature content (words). In one implementation the following set of classifiers may be used: Decision Tree, Naïve Bayes, Rule Based, Support Vector Machine, and Centroid-based. The classifiers are essentially machine-implementable sets of rules that can be applied to any data element in the warehouse to generate labels.

Once all classifiers in have been trained, their efficacy is evaluated by executing each of them on the test set “E” and measuring how often they correctly identify the category of each test document. For instance, as measures of such accuracy per category, precision and recall may be used. For a given category, “precision” is the number of times the correct assignment was made (true positives) divided by the total number of assignments the model made to that category (true positives plus false positives), while “recall” is the number of times the correct assignment was made (true positives) divided by the true size of the category (true positives plus true negatives). After all evaluations are complete for every category and model combination, the classifier with the highest precision and recall is used for classifying the set “CM” of still-unclassified documents. At block 46 the text clustering “TC” and set “CM” of unclassified documents are accessed by, e.g., loading them from cache. The text clustering “TC” is then saved as a new classification dimension 26 in the data warehouse 12 at block 48. The classification dimension is thus useful for searching for documents by classification derived from words in unstructured text fields.

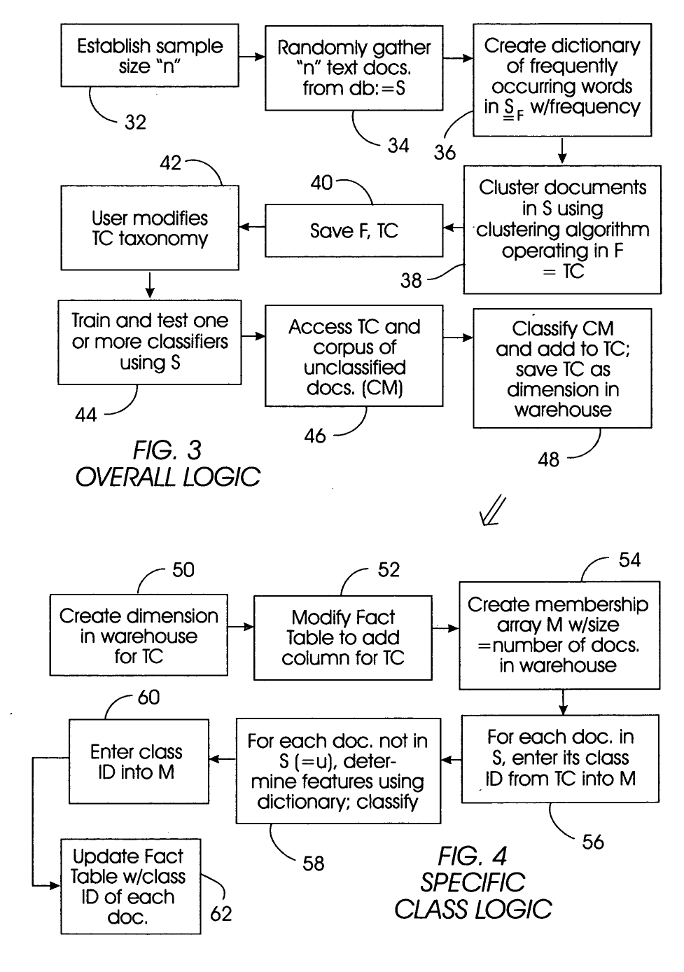

According to the present invention and referring with greater specificity to FIG. 4, the classification dimension 26 is created at block 50 and has a primary key and levels representing the classes. The fact table 20 is then modified at block 52 with a column for the classification dimension 26, as shown in FIG. 2. Next, at block 54 a membership array “M” is created that is the size of the total number of document ID's in the data warehouse 12. For each document “x” in the sample array “S”, a corresponding field M[x] in the membership array “M” is filled with the appropriate class ID from the text clustering “TC” at block 56.

Next, at block 58 it is determined, for each document “x” in the set “U” of documents in the data warehouse 12 but not in the sample array “S”, features “f” are determined using the text clustering dictionary. The class to which the document belongs is determined using the classifier chosen in FIG. 3 above. At block 60, for each document “x” in the set “U”, its corresponding field M[x] in the membership array “M” is set equal to the appropriate class. Once the membership array “M” has been completely filled, at block 62 all of the document ID's in the fact table are updated with their appropriate membership. “Code Sample 1” below illustrates one non-limiting exemplary implementation of the logic of FIGS. 3 and 4.

With the above invention in mind, it may now be appreciated that, based on only a sample of documents in the warehouse, a classification dimension listing all documents in the warehouse is established. The classification dimension can then be used to locate desired documents based on what appears in their unstructured text fields.

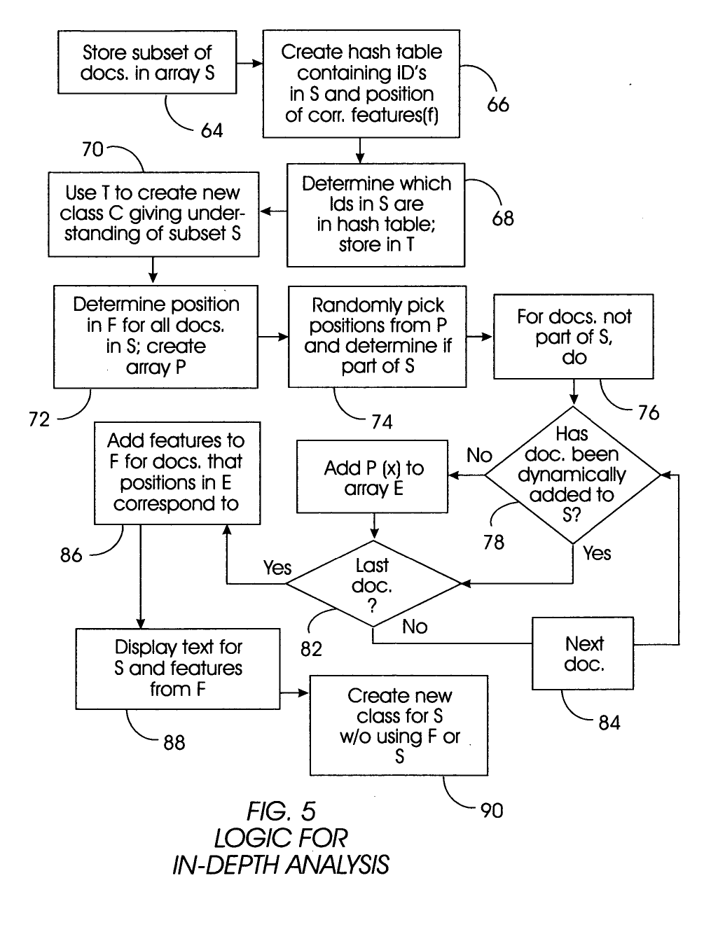

Using, e.g., an on line analytical programming (OLAP) tool, a user can also drill down and further explore a classification. FIG. 5 shows the logic for such further in-depth analysis. Commencing at block 64, a subset of documents in the sample array “S” can be stored in a smaller array “s”. At block 66 a hash table “H” is created which contains the ID's of documents in the sample array “S” and the position of their corresponding features in the feature space “F”. Proceeding to block 68, it is determined which ID's in the smaller array “s” are contained in the hash table “H”, and these IDs are stored in a table “T”. It may be appreciated that the table “T” contains the positions in the feature space “F” for all of the documents in both arrays “s” and “S”. Using the table “T”, a new class “C” is created at block 70 which gives a user a general understanding of a specific subset. “Code sample 2” below shows one non-limiting exemplary implementation of this logic.

Moving to block 72, it is determined what the position in the feature space “F” would be for all documents in the smaller array “s”. A position array “P” is created of documents in “s” versus corresponding positions the feature space “F”. If the size of the smaller array “s” is greater than a pre-defined threshold, “s” may be sampled using the principles above.

Next, at block 74, the logic randomly picks positions from the position array “P” and determines if they are part of the sample array “S”. The positions in the sample array “S” should correspond to the positions in the feature space “F”. For example, position 1 in the sample array “S” should have the features of position 1 in the feature space “F”. If P[x] (the entry in the position array “P” corresponding to the document “x”) is greater than the size of the sample array “S”, then the sample array “S” does not contain the document ID to which P[x] corresponds.

Block 76 indicates that a “do” loop is entered for all of the documents that are not part of the sample array “S”. At decision diamond 78 it is determined whether the document has been dynamically added to the feature space “F”, and if not, at block 80 P[x] is added to an array “E” of positions that must be added to the feature space “F”. From block 80, or from decision diamond 78 in the event that the document under test has already been added to the sample array “S”, the logic determines at decision diamond 82 whether the last document in the “do” loop has been tested and if not, the next document is retrieved at block 84 and the logic loops back to decision diamond 78. When the last document has been tested, the logic exits the “do” loop and moves to block 86 to add the features to the feature space “F” for the documents to which the positions in the array “E” correspond. If desired, at block 88 all of the text for the smaller array “s” and the appropriate features from the feature space “F” may be displayed to provide the user with a detailed understanding of a specific subset. Code sample “3” provides a non-limiting implementation of this logic.

If desired, the logic may proceed to block 90 to create a new class for the documents in the smaller array “s” without using the feature space “F” or the sample array “S”. Specifically, if the size of the smaller array “s” is greater than a pre-defined threshold, a sample array “z” of the smaller array “s” is created. Or, the entire smaller array “s” can be used to establish the sample array “z”. By analyzing all of the documents in “z” a new feature space specifically for “z” is created. Along with the new feature space, a new classification is created. This method provides the most detailed information, but it also the most time consuming.

The above invention can be implemented as a computer, a computer program product such as a storage medium which bears the logic on it, a method, or even as a service. For instance, a customer may possess the data warehouse 12. The logic can be implemented on the customer's warehouse and then appropriate data (e.g., the classification dimension and/or an analysis of documents in a customer's warehouse using the classification dimension) can be returned to the customer.

Code Sample 1

```
int[ ] ids = new int[size];
M = new int[size];
// determine the membership of the ID's contained in S
Hashtable membershipHash = new Hashtable( );
int pos = 0;
for (int i=0; i < tc.nclusters;i++){
    Integer grp = new Integer(i);
    if (!membershipHash.contains(grp)){
            membershipHash.put(grp,new Vector( ));
          }
          int[ ] mems = TC.getClusterMemberIDs(i);
          for (int j=0;j<mems.length;j++){
            progress++;
            allIds.remove(new Integer(mems[j]));
            ids[pos] = mems[j];
            M[pos] = i;
            pos++;
          }
      }
      // determine the unclassified ID's
      int[ ] unClassified = new int[allIds.size( )];
      Enumeration uc = allIds.keys( );
      int tmpPos = 0;
      while (uc.hasMoreElements( )){
          Integer x = (Integer)uc.nextElement( );
          unClassified[tmpPos] = x.intValue( );
          tmpPos++;
      }
      Arrays.sort(unClassified);
      // classify the unclassified documents
      // Set our reader to the unclassified ID's
      FileTableReader ftr = new FileTableReader(unClassified);
      // Load our dictionary from TC
      Dictionary d = new Dictionary(TC.getDictionary( ));
// for each ID in unclassified, read the line from the database. Create
features
                        using d and classify
for (int i=0;i<unClassified.length;i++){
  progress++;
  String line = ftr.readLine( );
  StringVector sv = d.stringToStringVector(line);
  FEATURES f = d.createFeatures(line);
  int c1 = TC.classify(f);
  M[pos] = c1;
  ids[pos] = unClassified[i];
  f = null;
  pos++;
}
ftr.reset( );
// create a hash table for each cluster with all of the ids part of that cluster
Hashtable idsHash = new Hashtable(ids.length);
Vector sqlStatements = new Vector( );
countTimes = 0;
for (int x=0;x<ids.length;x++){
    Integer s = new Integer(ids[x]);
  String tmp = (String)idsHash.get(s);
  if (tmp == null){
      Integer grp = new Integer(M[x]);
      Vector tmpIds = (Vector)membershipHash.get(grp);
      tmpIds.add(s);
      membershipHash.put(grp,tmpIds);
      idsHash.put(s,“YES”);
  }
}
// Update the fact table
Enumeration e = membershipHash.keys( );
while (e.hasMoreElements( )){
  Integer key = (Integer)e.nextElement( );
  // Our update string. We will batch 100 at a time.
    String updateSql =
    “UPDATE“+IDatabaseFields.SCHEMA+”.
    “+IDatabaseFields.FACT_TABLE+” SET
    “+dyn_name+”_ID=“+key.toString( )+” WHERE
    “+IDatabaseFields.DOCUMENT_ID_COLUMN+” IN
    (?,?,?,?,?,?,?,?,?,?,?,?,?,?,?,?,?,?,?,?,?,?,?,?,?,?,?,?,?,?,?,?,?,?,?,?,?,
    ?,?,?,?,?,?,?,?,?,?,?,?,?,?,?,?,?,?,?,?,?,?,?,?,?,?,?,?,?,?,?,?,?,?,?,?,?,?
    ,?,?,?,?,?,?,?,?,?,?,?,?,?,?,?,?,?,?,?,?,?,?,?,?,?)”;
  //  Get our ids.
  Vector idsString = (Vector)membershipHash.get(key);
    int position = 0;
    // prepare the statement
  PreparedStatement finalStatement = m_conn.prepareStatement
  (updateSql);
  Vector tmpIds = new Vector(100);
  for (int i=0;i<idsString.size( );i++){
      int tmpId = ((Integer)idsString.get(i)).intValue( );
      // if < 99 add the id to the statement and continue
        // else add and then execute
      if (position < 99){
          tmpIds.add((Integer)idsString.get(i));
          finalStatement.setInt(position,tmpId);
      } else {
          tmpIds.add((Integer)idsString.get(i));
          finalStatement.setInt(position, tmpId);
          finalStatement.execute( );
          position = 0;
          tmpIds.clear( );
      }
  }
  // Check if there were less then 100 ids in the last loop. Rebuild the
    // statement to the right size, and execute
  if (position !=0 ){
        updateSql =“UPDATE
        “+IDatabaseFields.SCHEMA+”.
        “+IDatabaseFields.FACT_TABLE+” SET
        “+dyn_name+”_ID=“+key.toString( )+” WHERE
        “+IDatabaseFields.DOCUMENT_ID_COLUMN+” IN (?”;
        for (int i=1;i<position;i++){
          updateSql += “,?”;
      }
      updateSql += “)”;
      finalStatement = m_conn.prepareStatement(updateSql);
      for (int i=0;i<position;i++){
        finalStatement.setInt(i+1,((Integer)tmpIds.get(i)).intValue( ));
      }
      finalStatement.execute( );
  }
}
```

Code Sample 2

```
// create a temporary Vector
Vector tmpVec = new Vector ( );
// create a hash table for the documents in the sample and fill it
Hashtable H = new Hashtable (SIZE OF ORIGINAL SAMPLE);
for (int i=0; i< SIZE OF ORIGINAL SAMPLE; i++) {
    Integer x = new Integer (ID IN ORIGINAL SAMPLE ARRAY);
  Integer y = new Integer (POSITION IN FEATURE SPACE);
  H.put(x,y);
  x = null;
  y = null;
}
// Determine the ids in both s and S
for (int i=0;i<s.length; i++){
    Integer y = new Integer(s([i]);
  Integer x = (Integer) H.get(y);
  if (x != null)
      tmpVec.add(x);
}
H = null;
// Create array T and fill it
int[ ] T = new int[tmpVec.size( )];
for (int i=0;i<ids.length;i++){
    ids[i] = ((Integer)tmpVec.get(i)).intValue( );
}
tmpVec = null;
// Create a new text clustering C from F.
TextClustering C = new TextClustering( );
for (int i=0; i<ids.length; i++) {
    int pos = 0;
    pos = T[i];
// The variable newfeatures is an object containing pointers to the features
in F.
    newfeatures.pointers[i] = pos;
}
C.features = newfeatures;
C.classify( );
```

Code Sample 3

```
int[ ] P = POSITIONS IN F FOR DOCUMENT ID'S IN s;
TextClustering TC = LOAD TC FROM CACHE;
Arrays.sort(P);
// Determine our sample size for s
double cLevel = .05;
cLevel = (new Double(ConfigFile.cLevel)).doubleValue( );
double se = cLevel / 2.58;
double dss = ((.25) * (P.length)) / (((se*se) * (P.length)) + .25);
Double jdss = new Double(dss);
int ss = jdss.intValue( );
int tmpSs = ss;
int sizeOfS = S.length;
int[ ] E = null;
// If the length of s is greater than our predefined threshold, we will use a
sample of s
if (s.length > 100){
  Random rng = new Random( );
  Vector randomSampleIdsVect = new Vector( );
  Vector availablePoints = new Vector( );
  for (int i = 0; i < ss;i++){
    int x = rng.nextInt(P.length);
    Integer num = new Integer(P [x]);
    while (randomSampleIdsVect.contains(num)){
      x = rng.nextInt(P.length);
      num = new Integer(P [x]);
    }
    randomSampleIdsVect.add(num);
// If the position is greater than the size of S, check if the features have
already been dynamically added. If the position is less than the size of S,
we already have the features.
    if (num.intValue( ) > SIZE OF S){
      FEATURE f = F.get(num);
// If the feature has not been dynamically add put the point into a vector of
available points
      if (f == null)
          availablePoints.add(num);
    }
  }
// Create and fill an array containing the available points
  E = new int[availablePoints.size( )];
  for (int h=0;h<availablePoints.size( );h++){
    E [h]=((Integer)availablePoints.get(h)).intValue( );
  }
  Arrays.sort(E);
  availablePoints = null;
  rng = null;
} else {
// The threshold was not crossed, check all the ID's in s
    Vector availablePoints = new Vector( );
  for (int i = 0; i < P.length;i++){
// If the position is greater than the size of S, check if the features have
already been dynamically added. If the position is less than the size of S,
we already have the features.
    if (P[i] > SIZE OF S){
        FEATURE f = F.get(new Integer(P [i]));
// If the feature has not been dynamically add put the point into a vector of
available points
        if (f == null)
          availablePoints.add(new Integer(P [i]));
    }
  }
// Create and fill an array containing the available points
    E = new int[availablePoints.size( )];
  for (int h=0;h<availablePoints.size( );h++){
    E[h]=((Integer)availablePoints.get(h)).intValue( );
  }
  Arrays.sort(E);
  availablePoints = null;
}
FileTableReader ftr = new FileTableReader(E);
// Get our dictionary from TC.
Dictionary d = new Dictionary(TC.getDictionary( ));
// Read each document in E, create features and dynamically add to F.
for (int i=0;i< E.length;i++){
  String line = ftr.readLine( );
  FEATURE f = d.createFeatures(line);
  F.addDynamicRow(f, E[i]);
}
E = null;
P = null;
```

While the particular METHOD AND SYSTEM FOR ANALYZING UNSTRUCTURED TEXT IN DATA WAREHOUSE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

1. A computer-implemented method for analyzing information in a data warehouse, comprising:
selecting a sample of documents from the data warehouse;
generating at least one feature space of terms of interest in unstructured text fields of the documents using the sample;
generating at least one default classification using the feature space;
modifying the default classification to render a modified classification;
establishing at least one classifier using the modified classification; and
establishing a classification dimension in the data warehouse using the classifier.

2. The method of claim 1, further comprising adding documents not in the sample to the classification dimension, whereby the classification dimension is useful for searching for documents by classification.

3. The method of claim 1, wherein the classifier includes a machine-implementable set of rules that can be applied to any data element in the warehouse to generate a label.

4. The method of claim 1, wherein the sample is pseudo-randomly selected.

5. The method of claim 1, comprising displaying output using an on-line analytical tool (OLAP) tool.

6. The method of claim 1, wherein at least the act of generating a default classifier is undertaken using an e-classifier tool.

7. The method of claim 1, comprising:
identifying a subset of documents in the warehouse;
selecting features from the feature space that are relevant to the subset; and
comparing the subset with the sample using the features from the feature space that are relevant to the subset.

8. A service for analyzing information in a data warehouse of a customer, comprising:
receiving a sample of documents in the warehouse;
based on the sample, generating at least one initial classification;
using the initial classification to generate a classifier;
using the classifier to add documents not in the sample to a classification dimension; and
returning at least one of: the classification dimension, and an analysis rendered by using the classification dimension, to the customer.

9. The service of claim 8, comprising allowing a user to modify the initial classification.

10. The service of claim 8, wherein the classification dimension is useful for searching for documents by classification.

11. The service of claim 8, wherein the classifier includes a machine-implementable set of rules that can be applied to any data element in the warehouse to generate a label.

12. The service of claim 8, wherein the sample is pseudo-randomly selected.

13. The service of claim 8, comprising displaying output using an on-line analytical tool (OLAP) tool.

14. The service of claim 8, wherein at least the act of generating an initial classifier is undertaken using an e-classifier tool.

15. The service of claim 8, comprising:
identifying a subset of documents in the warehouse;
selecting features from the feature space that are relevant to the subset; and
comparing the subset with the sample using the features from the feature space that are relevant to the subset.

16. A computer executing logic for analyzing unstructured text in documents in a data warehouse, the logic comprising:
establishing, based on only a sample of documents in the warehouse, a classification dimension listing all documents in the warehouse, the classification dimension being based on words in unstructured text fields in the documents.

17. The computer of claim 16, wherein the establishing act undertaken by the logic includes:
selecting a sample of documents from the data warehouse;
generating at least one feature space of terms of interest using the sample;
generating at least one default classification using the feature space;
modifying the default classification to render a modified classification;
establishing at least one classifier using the modified classification; and
implementing the classification dimension in the data warehouse using the classifier.

18. The computer of claim 17, wherein the logic executed by the computer further comprises adding documents not in the sample to the classification dimension, whereby the classification dimension is useful for searching for documents by classification.

19. The computer of claim 17, wherein the classifier includes a machine-implementable set of rules that can be applied to any data element in the warehouse to generate a label.

20. The computer of claim 17, wherein the sample is pseudo-randomly selected.

21. The computer of claim 17, comprising displaying output using an on-line analytical tool (OLAP) tool.

22. The computer of claim 17, wherein at least the act of generating a default classifier is undertaken using an e-classifier tool.

23. The computer of claim 17, wherein the logic executed by the computer includes:
identifying a subset of documents in the warehouse;
selecting features from the feature space that are relevant to the subset; and
comparing the subset with the sample using the features from the feature space that are relevant to the subset.

24. A computer program product having means executable by a digital processing apparatus to analyze data in a data warehouse, comprising:
means for selecting a sample of documents from the data warehouse;
means for generating at least one feature space of terms of interest in unstructured text fields of the documents using the sample;
means for generating at least one classification using the feature space;
means for establishing at least one classifier using the classification;
means for identifying a subset of documents in the warehouse;
means for selecting features from the feature space that are relevant to the subset; and
means for comparing the subset with the sample using the features from the feature space that are relevant to the subset.

25. The computer program product of claim 24, comprising:
means for implementing a classification dimension in the data warehouse using the classifier.

26. The computer program product of claim 25, further comprising means for adding documents not in the sample to the classification dimension.

27. The computer program product of claim 24, wherein the classifier includes a machine-implementable set of rules that can be applied to any data element in the warehouse to generate a label.

28. The computer program product of claim 24, wherein the sample is pseudo-randomly selected.

29. The computer program product of claim 24, comprising means for displaying output using an on-line analytical tool (OLAP) tool.

30. The computer program product of claim 24, wherein at least the means for generating a default classifier includes an e-classifier tool.
